(19) United States
(12) Patent Application Publication
(10) Pub. No.: US 2022/0351305 A1
(43) Pub. Date: Nov. 3, 2022

(54) Systems and Methods for Facilitating a Marketplace for Organic Productions

(71) Applicant: Seyed Hesam Ghodsi, Western Springs, IL (US)

(72) Inventor: Seyed Hesam Ghodsi, Western Springs, IL (US)

(73) Assignee: Seyed Hesam Ghodsi, Western Springs, IL (US)

(21) Appl. No.: 17/242,980

(22) Filed: Apr. 28, 2021

(51) Int. Cl. G06Q 50/02; G06Q 30/00; G06Q 30/06

(52) U.S. Cl. CPC G06Q 50/02; G06Q 30/018; G06Q 30/0623

(57) ABSTRACT

This application discloses a computer-implemented platform which matches buyers and sellers of produced organic products and facilitates their transactions and the delivery of produces by using an online marketplace. This invention provides the registered producers with access to knowledge, technology, and requirements of organic productions. This invention also allows the registered sellers or producers to list their products on the online marketplace for sales. Customers and visitors can see the product information on the online website and place their orders. This invention facilitates the processes of marketing, sales, financial transactions, and delivery of the purchased goods. In addition to organic produces, this invention has also applicability to production and sales of non-organic products.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Producers of organic products need access to information related to proper production of organic products. These information are currently provided through different websites on the internet. There is also a need that the said information be provided to producers based on the geographical locations of the producers and the specific time of the year that the producers intend to produce the organic product. Producers of organic products need to sell their products to individual or wholesale buyers. As such, producers need to market for their products and find proper buyers. Depending on factors such as the proximity of a buyer and the seller, that buyer and seller may or may not be a good match. Producers also need to obtain certifications for their products through reputable agencies. Currently, there is no network or internet-based platform or website that integrates all of the aforementioned needs, to provide information to producers, to match buyers and sellers who are more suitable for each other, to provide information based on geographical locations of buyer and seller and environmental conditions, to obtain certification for their products, and to provide sale transactions through the platform.

Embodiments of this invention provide methods and apparatus to facilitate production, sales, and distribution of organic products by allowing producers to have access to materials, technologies, information regarding requirements of the organic production, and an internet-based platform to market and sell their products. Some embodiments of this invention provide the buyers with abilities to search, find, and buy their organic needs through an internet-based platform. Some embodiments of the invention further allow accessibility to less expensive organic products by introducing a certification process that reduces the cost of organic production. Some embodiments of the invention provide methods and apparatus that permit certain retailers and suppliers who are not local producers to sell their products on an online platform. In some example embodiments, the online sale offerings are available to member and nonmember customers who are visiting the platform. No platform is presently believed to exist through which a producer, supplier, or retailer of organic products can access to the supply chain of the organic production including ingredients, technology, in-house certification process, and online platform to market and sell the organic goods. In this implementation, the platform functions as a place where demand and supply for produced organic goods meet and transaction and delivery is facilitated. The platform owner may be compensated by a combination of revenues from sale of organic production ingredients, technology, equipment, or a transaction fee based on the sale of the organic goods through the platform.

BRIEF SUMMARY OF THE INVENTION

Some embodiments of the invention provide a system and method for facilitating production, marketing, sales, delivery, and accessibility of organics. Accordingly, customers can have access to required technology and information through the platform for producing organics. In some example embodiments, the platform provides the customers with access to raw materials such as seeds, soil, and fertilizer for producing organics. A potential customer, who is interested in producing organics may join the platform as a member (“Member Producer”). This membership may be obtained with or without a fee and by providing the individual's information such as personal and contact information as well as bank account, credit card, or PayPal (or any other mean of financial transaction) information for any potential financial transaction through the platform. Depending on members' needs, the member producers can order or purchase required materials to set up the infrastructure for the organic production. Member producers can also buy organic raw materials such as organic seeds, soil, fertilizer, and pesticides for organic production. The data for all raw materials and purchases and the frequency of purchases may be recorded and stored. A member producer may use the organic product producing methodology and the raw materials that are supplied by the platform for organic production. A member producer can also utilize information provided by the platform that help maintain a desired temperature and humidity which are optimum for the production in a closed environment such as a greenhouse. Moreover, in some example embodiments of the invention, the environmental conditions of the production field such as temperature and humidity can be sensed, recorded, and analyzed by incorporated technologies and using platform's optimization algorithms. Accordingly, the time interval during which organics will be ready for harvesting will be estimated. A member producer may post a sales ad on the platform for crops. In some example embodiments, the said ad will be displayed and is accessible for potential buyers through a menu tree. In other example embodiments, the ad may be displayed through other features of the platform.

In some example embodiments of the invention, the platform may record the purchase history of organic raw materials of a member producer. In other example embodiments, the platform may record the information that member producers provide along with the time and the date such information are provided. The platform may use the purchase history of a member producer for organic certification process and assure the buyers that the raw materials used in the production are organic. Such certification may only be awarded to member producers who purchased all raw materials from the platform or an approved third-party platform. A member producer may be required to satisfy other conditions to obtain organic certification. In addition to platform's certified organic products, non-certified products can also be posted and displayed for sales on the platform. In some example embodiments of the invention, by checking a menu tree or other features of the platform, buyers can find their needs, see pictures, read the descriptions of items (such as date and time of harvest, price, and delivery options), compare different items, and make their orders through the platform. A financial transaction may take place and similar to any other online transaction, the total balance will be transferred from the buyer's bank, PayPal, or the platform's internal account to a seller's account. In some example embodiments, since the platform is designed and structured for demands, a member producer may provide delivery options such as free shipping, charging a fee for the delivery, or pick up by a buyer. In some example embodiments, a member producer or seller may pack the sold items, preferably using environmental friendly packages provided by the platform or an approved third-party platform, and deliver all orders together or separately to buyers. A member producer or seller may also make the packages available for the buyers to pick up. In some example embodiments of the invention, since the delivery is made to nearby destinations and since the food-mileage is low, fresh organics can reach final costumers faster, they may last on the hands of the consumers longer, and their waste would be lower.

In some example embodiments of the invention, a buyer has a limited predefined time period to return the purchased items. However, that buyer is responsible for returning the items to seller's location, pay for the return costs, or provide evidences and reasoning for his/her dissatisfaction so that the platform can cancel the order and refund the payment. In some example embodiments, the seller is responsible for the return cost. Some embodiments of the invention use statistical and mathematical optimization and pattern recognition algorithms such as machine learning and deep learning to analyze the purchasing, producing, sales, and consumption data of the member producers to assure that member producers are using organic raw materials.

### BRIEF DESCRIPTION OF THE SEVERAL VIEWS OF THE DRAWING

FIG. 1 shows a part of an example embodiment of the invention where it depicts a simplified diagrammatic flow that the platform offers to a seller or producer.

FIG. 2 shows a part of an example embodiment of the invention where it depicts a simplified diagrammatic flow that the platform offers to a buyer.

FIG. 3 illustrates a simplified diagram of the modules of an example embodiment of the invention.

FIG. 4 presents a simplified diagrammatic flow representation of an optimization process in an example embodiment of the invention.

FIG. 5 presents a simplified diagrammatic flow representation of pattern recognition capability of the platform.

### DETAILED DESCRIPTION OF THE INVENTION

Different examples will be described in details that represent some example embodiments of the present invention. While the technical descriptions presented herein are representatives for the purposes of describing the present invention, the present invention may be embodied in many alternate forms and should not be limited to the embodiment presented herein.

The described examples can be modified in various alternative forms. Unless otherwise stated, there is no intention to limit the invention to the particular forms disclosed herein. However, examples are used to describe the present invention and to cover some modifications or alternatives within the scopes of the invention.

The spatially relative terms which may be used in this document such as “underneath”, “below” and “above” are for the ease of description and to show the relationship between an element and another one in the figures. If the described object is turned over, elements described as “underneath” or “below” other elements would then be “above” other elements. Therefore, for example, the term “underneath” can represent an orientation which is below as well as above. If the object is rotated, the spatially relative terms used herein should be interpreted accordingly.

Unless otherwise stated, the terms used herein have the same meanings as commonly understood by someone with ordinary skills in the invention field. It should be understood that the provided example embodiments of the present invention may just have features or illustrations that are mainly intended to show the scope of the invention and different designs of other sections of the presented example implementations are expected.

Throughout this document, an entire drawing of the provided example embodiments may not be presented for the sake of simplicity. This can be understood by someone with ordinary expertise in the field of invention. For example, when show a flowchart, we may just show steps that are more critical for explaining the related invention embodiment and avoid showing the noncritical steps. In such cases, any new or well-known designs or implementations for the un-shown parts are expected. Therefore, it should be understood that the provided example embodiments may just have illustrations that are mainly intended to depict a scope of the present invention and different implementations of other parts of the presented example embodiments are expected.

### Some Benefits of the Invention

This invention may provide opportunities for a better use of land specially in the residential areas. It may also increase the supply of locally produced organic products and encourage homeowners to grow and consume their own organics. This invention may also enable homeowners to sell their excess organic supplies to their communities and make fresh organics accessible for more people at lower prices. Depending on the jurisdiction, if the production is performed in properties that their main functionality is not farming (e.g. residential or industrial properties), the property tax may not pass through to the organics' final prices as farming or gardening is not the main and primary use of these properties. Selling excess supply through the platform may provide for reducing the product waste and compost. In many regions, organic certification is an exclusive and expensive process. Many local farmers cannot justify the expenses for organic certification. Because the technology, requirements, raw materials, and ingredients of the production are provided by the platform or a third-party trustee of the platform, the platform can issue its own certification for production. The platform's certification and labeling systems may serve as tools to enhance distribution and market development, create trust, and foster confidence in buyers that the platform's certified goods are produced organically or non-GMO. The locality of the production may help cut the distribution costs and time. It may also reduce the food mileage of the organics. Because the organic products may not contain preservatives, vicinity to the final consumers plays a fundamental role in increasing efficiency in organic markets and the supply chain. While the platform website focuses on organically produced goods, it may also be a suitable platform for third-party sales featuring environmentally friendly or other complementary products. In addition, third party producers, service providers, and distributors may be able to broaden their role from simply that of a product or service supplier to a direct seller of their items. This invention may open a large market for sellers or producers. It may also eliminate barriers to scalability facing producers and make their production feasible. As described above, the platform may help decrease the fixed cost of the organic productions. This invention may create a new revenue channel for the property owners or renters. It may encourage households and children to learn more about nutrition, environment, and organic productions. It may also promote the environmentally friendly practices. Moreover, it may also increase interactions between the members of communities. As the majority of the producers are also consumers of what they are producing, possibilities for moral hazards may be diminished and the quality of the production may be improved.

### Field of Invention

Without limiting the scope of the invention, the present invention relates to the expansion and facilitation of organic productions and accessibility by using internet. Through creation of a platform whereby organic producers can access to required items, knowledge, means of the production, sales and delivery of organic crops.

### Definitions

Seller-Seller is an individual or an entity using the platform to sell products on the platform. A seller can be a member or a non-member. However, if a seller wants to sell a product as the platform's certified product, that seller needs to be a member and use the platform or its third-party raw materials in the production process.

Buyer-Buyer is an individual or an entity using the platform to buy materials that are displayed on the platform for sales. A buyer can be a member or a non-member. A member buyer is provided with information and facilitations in return for the paid membership fee.

Producer-A producer is an individual or an entity using the platform's information, instruction, or technology to produce organic products.

Member-A member is a producer, seller, or buyer who pays a membership fee to benefit from the platform's services.

Customer-A customer is a prospective seller or a prospective buyer who accesses and visits the platform to sell or buy products or services. Customers can be either the platform's member or a non-member.

### Detailed Description

Some embodiments of the invention provide a platform that facilitates marketing, sales, and delivery of locally produced organics. In some example embodiments, the platform provides technology, hardware, and raw materials needed for the smaller scale farming. In some example embodiments, the platform minimizes food mileage and waste, decreases the production costs, and widens accessibility to organic productions.

In some embodiments of the invention, a member producer can purchase the instruction, hardware, software, and organic raw materials from the platform. The said member producer can then set up the required production infrastructure and start producing organics. The analysis of the collected production data by the platform may not only help the producer optimize the production process but it may also assure the customers that the production was performed organically and by using organic materials and procedures. Some embodiments of the invention may also allow non-members to visit the platform's website, list their productions for sales under non-certified categories, or make purchases.

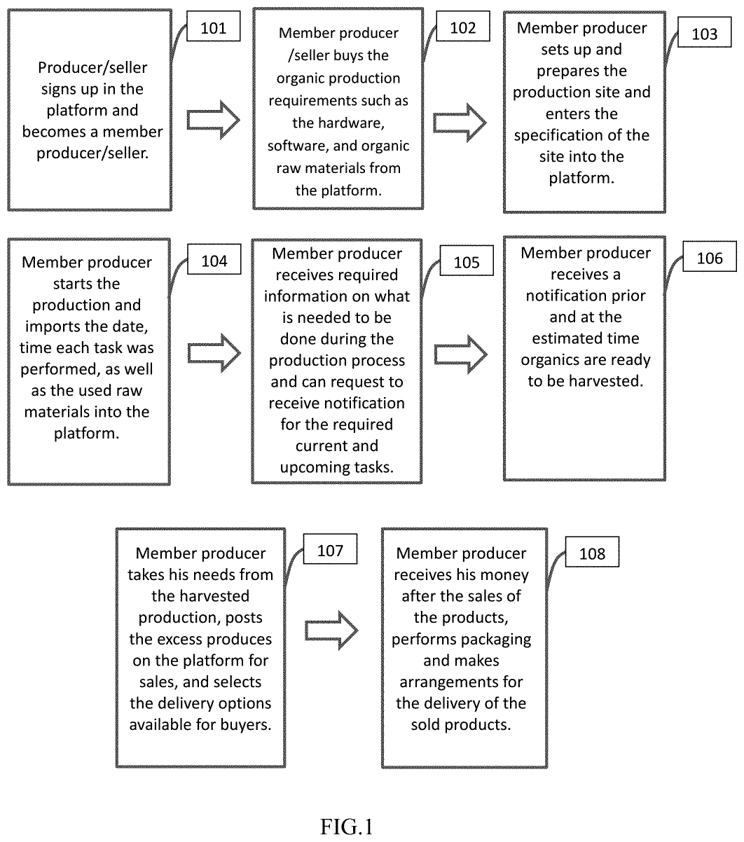

FIG. 1 shows a part of an example embodiment of the invention where it depicts a simplified diagrammatic flow of the services that the platform offers to a seller or producer. During step 101, prospective producer aiming to produce organics and sell them in the platform signs up in the platform using the information needed for creating an account. In some example embodiments, the said prospective producer also enters information about the number of households and the climate of the environment where the production would take place. After creating an account, the said prospective producer becomes a member producer of the platform. A member producer can also purchase the production technology, hardware, and software that are required to set up the organic production infrastructure from the platform (102). If a member producer is planning to sell the productions or crops as organics, that member producer is required to purchase organic raw materials such as seeds, soil, fertilizer, and pesticides from the platform or its third-party trustee and only use these materials in the production process. Member producer sets up a production site and enters its specification such as size, features, and location (103). Member producer can also use the technology provided by the platform such as climate sensors. These sensors report the information regarding production environment and climate to the platform (303, 307). Through using the cloud capabilities of the platform (308), these collected data is stored (403) and analyzed by the platform algorithms and the results of the analysis will help the member producer to have an optimal production process (404). Referring to FIG. 1, the member producer starts the production process by using organic raw materials provided by the platform or a third-party trustee of the platform and inputs the amount of the raw materials used, details of the performed tasks, and the date and time that each task was done into the platform (104). The platform may use these data to analyze and estimate the time of each step of production as well as the harvest. The platform may also use these data to determine if there is any suspicious and questionable activity in the use of the organic raw materials. The existence of such suspicious activities may impact the certification process. During the production process, the platform provides interactive instruction or coaching services, computerized or by a representative, to walk the member producer through different steps of the production (105). The platform also sends heads up notifications for each current and new task that needs to be performed (105). Any of these services may be added to the initial purchased package by paying an extra fee by a member producer any time during the production process, or they can be included in the initial paid order of the platform service package. After performing each step, the member producer updates the producer's account with date and time of the task finished. The imported data may be used by the platform to calculate the timing of the next task as well as to find abnormal and suspicious behaviors in violation of certification requirements (302, 303, 307, 308). By collecting data from the entire process of the production as well as data from the climate of the production site, the algorithm calculates the optimum harvest time of the organics and sends notifications to the member producer prior and at the time the organics are ready to be harvested (106, 302, 307, 308). This functionality may assure the freshness of the production, cut the wastes, free the space for future production periods, and optimize the use of energy and materials during the production process. The member producer takes his needs from the harvested production, lists the excess produces on the platform for sales, and selects the delivery options available for the potential buyers (107, 303, 304, 305, 306, 307). Depending on the type and features of the production and the preferences of the producer or the seller, delivery may be performed by the member producer, platform, a third-party, or pick up by the buyer. The estimated handling and shipping times may be posted in the sales advertisement. In some example embodiments of the invention, after the purchase is made, money will be withdrawn from the buyer's bank or platform account and will be transferred to the platform account and held there until delivery of the product is completed. In some example embodiments of the invention, the member producer packages the product with environmentally friendly or recyclable packaging materials. In other example embodiments, the member producer packages the product with non-recyclable packaging materials. In some example embodiments, the packaging materials can be purchased from the platform or a third-party trustee of the platform. In some example embodiments, the member producer also prints a barcode for the item to facilitate tracking of the package. In some example embodiments, the buyer's payment will be transferred to the member producer or seller's bank or platform account after the item was delivered, pictured, and scanned at the destination. In some example embodiments, the member producer or seller may receive the money after a specific time after the delivery of sold item. In some example embodiments, the aforementioned specific time may decrease or increase depending on different conditions such as the past performance and reputation of the member producer or seller. In some example embodiments, the transaction data are collected for analysis of the credibility and behavior of the member producer, seller, or buyer, and also improvements of the production process or services offered by the platform.

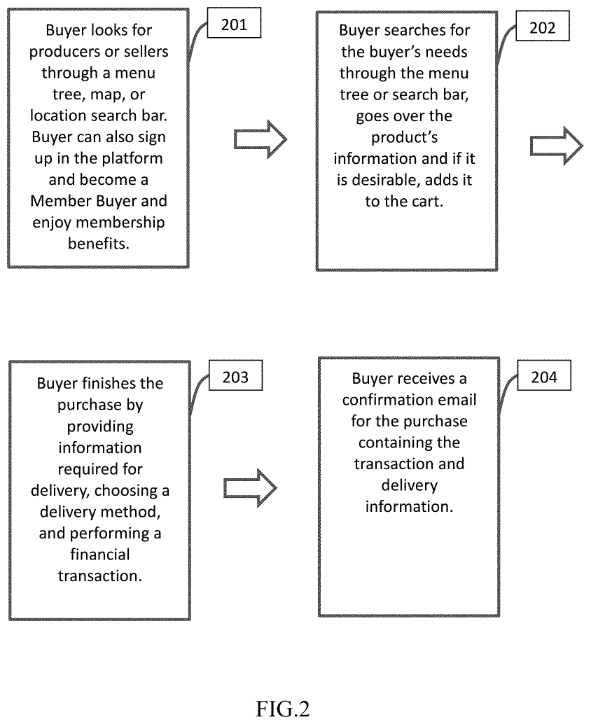

FIG. 2 shows a part of an example embodiment of the invention where it depicts a simplified diagrammatic flow that the platform offers to a buyer. (201, 301, 304, 307, 308) A buyer searches for producers or sellers that are close to buyer's location through a menu tree, the location search bar, or any other feature provided by the platform (201). In some example embodiments, a buyer may search based on a product name that are not necessarily located or stored in physical proximity of the buyer. In some example embodiments of the invention, the buyer can also sign up in the platform and becomes a member buyer and use the platform's benefits such as scientific newsletters on organic production and pre-purchase programs of the organics which are of high demand in the market. The buyer searches for the buyer's needs through a menu tree, a map, a search bar, or any other feature provided by the platform and using the product's, producers', or seller's information such as the vicinity of the seller, delivery options, or harvest date (202). If the product is desirable for the buyer, the buyer adds it to the cart. The buyer then finishes the purchase process by providing information required for the delivery, choosing a delivery method, and performing the financial transaction (203). The payment can be made from the buyer's bank account or the buyer's account in the platform. The buyer then receives a confirmation email or a notification via a text message for the purchase containing the transaction and delivery information (204). In some example embodiments of the invention, after delivery or pick up by the buyer, the buyer has a specific time window to report any issue or dispute about the transaction. In these cases, the buyer should support the dispute by providing enough evidence that the conditions of the sold product are not consistent with what was advertised and claimed by the seller. In these cases, the platform is responsible to perform investigations and mitigate the issue.

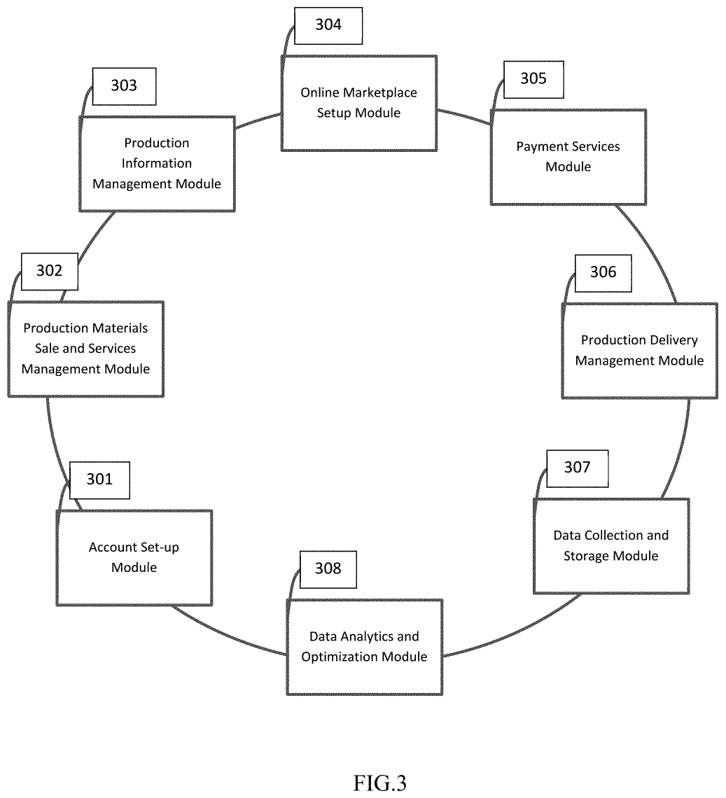

FIG. 3 illustrates a simplified diagram of the modules of an example embodiment of the invention. The Account Set-up Module allows potential buyers, producers, or sellers to join the platform, become a member, and benefit from the platform services (301). Different levels and options may be available for the membership and various fees may be charged depending on the selected level of the membership. In some example embodiments, the account set-up process requires personal and bank account information. In some example embodiments, a member can decide to utilize an internal account managed by the platform. In some example embodiments, a member can utilize a bank account to make or receive payments. In some example embodiments, with an internal platform account, members are able to manage their financial transactions and transfer funds to and from their bank accounts. The Production Materials Sale and Services Management module contains and offers all the raw materials, instructions, technology, hardware, and software required for the production of organics (302). In some example embodiments, module 302 also offers consumer support and services for the sold materials. In some example embodiments, module 302 collects information on consumer satisfaction of sold materials and services. The Production Information Management module provides the information required for organic production process (303). In some example embodiments, module 303 is the data bank that contains instructions on the production process and the way the platform technology should be used. In some example embodiments, these information are updated periodically. Online Marketplace Setup Module is where buyers and sellers meet each other (304). In this module, the product information as well as terms and conditions of the trade are defined and presented (304). Payment Services Module provides information to customers about their accounts with the platform as buyers or sellers (305). Module 305 enables transactions for member and non-member customers. Promotions and special offers may also be managed through module 305. Production Delivery Management Module provides delivery related information of each transaction such as delivery options and tracking (306). In some example embodiments, module 306 also collects data for improvement of the delivery processes of the platform. Data Collection and Storage Module acts as the data center of the platform (307). All the data collected from all the processes in the platform are gathered and categorized by module 307. In some embodiments, the aforementioned data are used for optimization and enhancement of processes and forecasting capabilities of the platform. Data Analytics and Optimization Module uses predictive or pattern recognition algorithms to predict and detect cases such as task timing of the member producers and suspicious behaviors of member producers in violations of organic production protocols (308). Module 308 collects data from production processes, sales, and delivery.

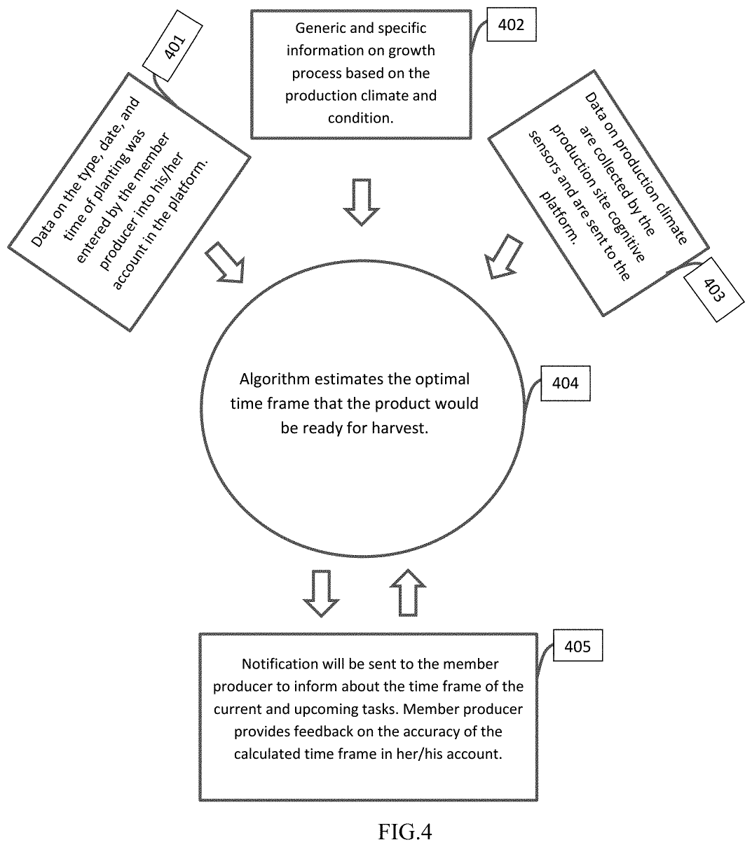

FIG. 4 presents a simplified diagrammatic flow representation of an optimization process in an example embodiment of the invention. Data of the type and the amount of the materials such as seeds, soil, and fertilizer, as well as date and time of the planting are entered by the member producer into a production account in the platform (401). Product generic and specific information on how the plant will grow considering the production climate, growth stages, and processes are drawn from the platform data bank as input data for the optimization process (402). Data on production climate are collected by the production site cognitive sensors and sent to the platform via the Internet or any other computer-based network (403). In some embodiments, cognitive sensors are part of the technology sold to the member producers to monitor the climate of the production site. One of the key elements of the optimization process is the algorithm that determines the optimal time frame the product would be ready for harvest. This algorithm can time the readiness of the crops for harvesting as well as the optimum time of each stage of the planting. In some example embodiments, the platform sends a notification the member producer to inform about the estimated time frame for each key step and about when the final product is ready for harvesting. In some example embodiment, the member producer rates the platform or fills out a survey on the accuracy of the provided time estimations. The algorithm may use the aforementioned rating or survey to optimize process and increase the accuracy of the future estimations or to use appropriate overlays between different time frames.

In some example embodiments of the invention, the platform may use the physical locations of the buyers and sellers to determine the areas of high demands and areas where a large number of sellers or producers are residing. In such example embodiments, the algorithm may use the said physical location for the purpose of allocating resources and services provided by the platform such as setting up storages for raw materials or hiring employees at a specific location. In other example embodiments, may offer local delivery services by hiring for example drivers in areas of high demand.

In some example embodiments of the invention, the platform notifies the producers or seller if there is an excess demand for a specific produce in the marketplace in the physical vicinity of the said producers or sellers. In some example embodiments of the invention, the platform may collect the purchase history of a producer and suggest to that producer additional items that the said producer may need to buy.

In some example embodiments of the invention, the platform may offer to rent the backyard or farmlands of local producer. In such example embodiments, the platform may hire employees to farm the said backyards or farmlands according to organic production protocols and pay a fee or a portion of a produce to the landowner.

In some example embodiments of the invention, the platform may offer to buy the produces of the sellers. In such example embodiments, the platform may store the produces that are perishable and later sell them to appropriate buyers. In other example embodiments, the platform may offer to store the produces of the sellers and charge a storage fee. In some example embodiments, the platform may provide a matching service to match the storage facilities to member producers or sellers to store their extra produces.

In an example embodiment of the invention the platform may offer to automate an entire or a part of the organic producing process such as watering or providing appropriate lighting or heat in greenhouses. In such example embodiments the said automated watering, heating, humidity or lighting systems may be connected to the platform through a computer-based network such as internet or WiFi. In said example embodiments, the platform may automatically turn ON or OFF the water, heat, humidity, or light depending on the geographical location of production, time of the day, date, or information that the platform receives from a sensor. In some example embodiments, the said sensor may be a heat senor or a light sensor. In other example embodiments, the said sensor is a humidity sensor. In some example embodiments of the invention, the platform may control the said water, heat, humidity, or light based on weather forecast data.

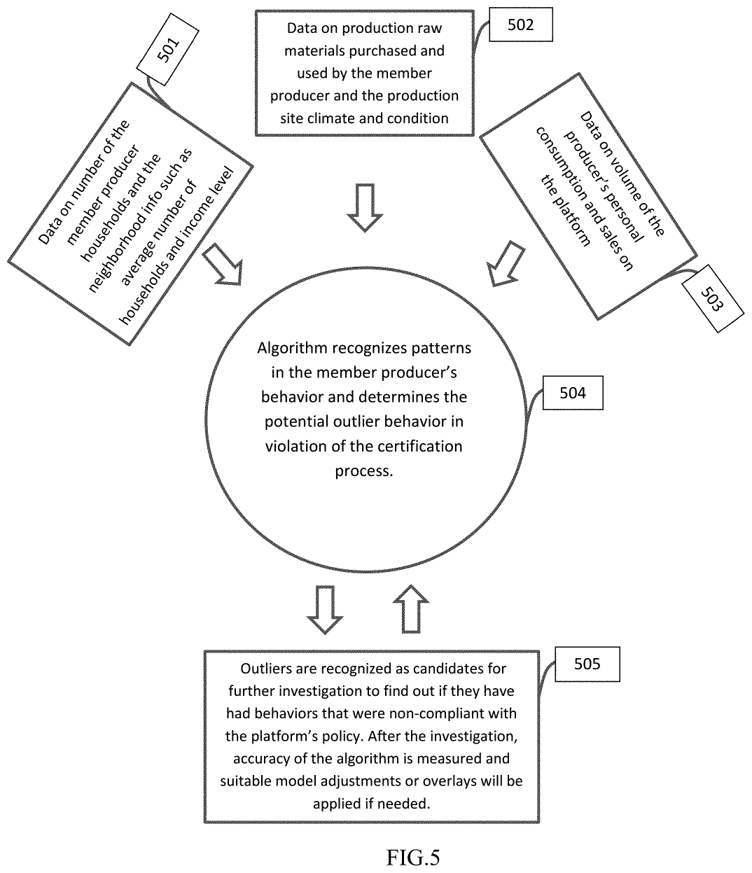

In some example embodiments of the invention, the platform may connect a first producer who is willing to offer a service to a second producer. The said services may include any step of the production or sales processes such as watering, delivery or harvesting. In such embodiments, the platform may connect the said first producer to the said second producer based on their physical location. In some example embodiments of the invention, the producers who offer their services may receive ratings from other producers. FIG. 5 presents a simplified diagrammatic flow representation of pattern recognition capability of the platform in an example embodiment of the invention. The pattern recognition process plays a critical role in this embodiment of the invention as it is extremely important to assure the platform costumers the organics are genuinely produced from organic materials and the production process complies with the requirements of the organic production (501). In some example embodiments of the invention, member producers who want to sell their products as organics in the platform are required to purchase their organic raw materials from the platform or its third-party trustee. In those example embodiments, the platform needs to ensure that all the crops offered for sales are from the purchased raw materials and no non-organic process or material was used in the production. Accordingly, demographic data on number of the member producer households and the neighborhood information such as the average number of households, their sizes, and income levels are collected by the platform. This data will be used to estimate the domestic consumption of producers. Data on raw materials purchased by the member producers and the production site climate are collected to predict if the production output is consistent with the used inputs of the production (502). Data on volume of the production sales through the platform by member producers are collected to determine the production output level sold on the platform and its consistency with the production output level claimed by member producers (503). An algorithm recognizes patterns in the member producers' behaviors, average produce they consume (not offered for sale), the amount of produces they offer for sales in the platform, and the amount of raw materials they used for the production. These information are used to predict the potential outliers and suspicious activities in violation of the organic certification process. For instance, detecting that none or a portion of the raw materials were purchased from the platform or its third-party trustee and the remaining portion of raw materials were non-organic may be indicatives of suspicious activities in violation of certification process or guidelines. In some embodiments of the invention, the said behaviors are detected, flagged, and investigated. Outliers are recognized as candidates for further investigations to find out if they have had behaviors that were non-compliant with the platform's policies and procedures (505). In some embodiments, after the investigation, the platform assesses the accuracy of the algorithm and applies suitable model adjustments or overlays to increase the precision of the future predictions.

1. A computer-implemented platform, said platform provides an information for production of a crop, wherein a first user signs up in the said platform as a producer, wherein the said platform provides the said information to the said first user, wherein the said information is specific to the physical location of the production site of the said first user.

2. The platform of claim 1, wherein the said crop is an organic produce.

3. The platform of claim 2, wherein the said platform provides a certification for an organic produce.

4. The platform of claim 1, wherein the said first user lists the said crop for sales.

5. The platform of claim 4, wherein a second user signs up in the said platform to buy an organic produce, wherein the said produce is listed by the said first user for sales.

6. The platform of claim 5, wherein the said platform connects a buyer to a seller based on their physical vicinity or product availability, wherein the said seller may not be a producer, wherein the said seller may be an appointee of a producer.

7. The platform of claim 5, wherein the said platform collects data from the said first and second users, wherein the said platform utilizes the said data to improve a process or a service offered by the said platform.

8. The platform of claim 7, wherein the said platform uses a pattern recognition or a data analyses method to analyze the said data.

9. The platform of claim 1, wherein the said platform receives a data from a sensor in the said production site, wherein the said platform uses the said data to modify the said information.

10. The platform of claim 9, wherein the said sensor is a humidity sensor, or a temperature sensor, or a light sensor, or a bacteria detection sensor.

11. The platform of claim 5, wherein the said platform receives a data from a sensor in the said production site, wherein the said platform uses the said data to modify the said information.

12. The platform of claim 11, wherein the said platform lists a raw material for sales.

13. A computer-implemented platform, said platform provides an information for production of a crop, wherein a first user signs up in the said platform as a producer, wherein the said platform provides the said information to the said first user.

14. The platform of claim 13, wherein the said first user lists the said crop for sales.

15. The platform of claim 13, The platform of claim 1, wherein the said crop is an organic produce.

16. The platform of claim 15, wherein a second user signs up in the said platform to buy an organic produce, wherein the said produce is listed by the said first user for sales.

17. The platform of claim 16, wherein the said platform collects data from the said first and second users, wherein the said platform utilizes the said data to improve a process or a service offered by the said platform.

18. The platform of claim 17, wherein the said platform uses a pattern recognition or a data analyses method to analyze the said data.

19. The platform of claim 16, wherein the said platform provides a certification for the said organic produce.

20. The platform of claim 16, wherein the said platform provides a method of financial transaction between the said first and second users.
